(19) United States
(12) Patent Application Publication
(10) Pub. No.: US 2023/0215347 A1
(43) Pub. Date: Jul. 6, 2023

(54) Image Display Control Method and Apparatus, and Image Display Device

(71) Applicant: LEYARD OPTOELECTRONIC CO., LTD., Beijing (CN)

(72) Inventors: Weilin LEI, Beijing (CN); Changjun LU, Beijing (CN)

(21) Appl. No.: 18/088,784

(22) Filed: Dec. 27, 2022

(30) Foreign Application Priority Data
Dec. 30, 2021 (CN) 202111663265.6

(51) Int. Cl. G09G 3/32

(52) U.S. Cl. CPC G09G 3/32; G09G 2320/08; G09G 2320/0209

(57) ABSTRACT

Disclosed are an image display control method and apparatus, and an image display device. The method includes: a refresh rate of a display screen is acquired; display time of a target image on a predetermined time axis is adjusted according to the refresh rate, so as to obtain adjusted display time, wherein the predetermined time axis is a refresh cycle of each frame of the target image when the display screen is at a target refresh rate; and according to the adjusted display time, the display screen is controlled to display the target image. According to the present disclosure, the technical problem of visual crosstalk when a Light Emitting Diode (LED) display screen displays a dynamic image is solved.

### TECHNICAL FIELD

The present disclosure relates to the technical field of image display, and specifically, to an image display control method and apparatus, and an image display device.

### BACKGROUND

In the current technical solution, images are generally displayed on a Light Emitting Diode (LED) display screen. For example, for a 60 Hz frame, a cycle is a 16.67 ms time axis, then when the image pixels are sent over at one frame cycle time, the image is uniformly displayed on the 16.67 ms time axis. FIG. 1 is a schematic diagram of an image uniformly displayed on a time axis according to the prior art. As shown in FIG. 1, Vsync is a field synchronization signal, each field starts with a field synchronization head, a display column is the time for displaying an image, and the number of the display column is the number of refresh rates. In normal cases, the display columns are uniformly scattered over the entire time axis of a field, which gives a good display effect.

However, the sense of human eyes is integral to light, so as to perceive the changes of the image. The human eyes continuously integrate emitted light, so as to continuously perceive the changes of the image. In this way, a temporal integral for the end of the previous frame image and the front of the next frame image is inevitably formed, while changes in content of the previous frame image and the next frame image are relatively large when a moving image is intense. Therefore, it is possible to see the crosstalk between the previous and next frames under the intense image. When the moving image is intense, crosstalk between the previous and next frame images causes blurring of an object image.

In view of the above problems, no effective solution has been proposed yet.

### SUMMARY

Embodiments of the present disclosure provide an image display control method and apparatus, and an image display device, to at least solve the technical problem of visual crosstalk when an LED display screen displays a dynamic image.

An aspect of an embodiment of the present disclosure provides an image display control method. The method includes: acquiring a refresh rate of a display screen; adjusting display time of a target image on a predetermined time axis according to the refresh rate, so as to obtain adjusted display time, where the predetermined time axis is a refresh cycle of each frame of the target image when the display screen is at a target refresh rate; and according to the adjusted display time, controlling the display screen to display the target image.

As at least one example embodiment, the operation of adjusting display time of the target image on the predetermined time axis according to the refresh rate, so as to obtain the adjusted display time includes: compressing the display time according to the refresh rate, so as to obtain the adjusted display time. The compression processing is configured to compress a duration of the display time on the predetermined time axis.

As at least one example embodiment, the operation of compressing the display time according to the refresh rate, so as to obtain the adjusted display time includes: judging whether the refresh rate is greater than a refresh rate threshold; when the refresh rate is greater than the refresh rate threshold, using a first processing mode to compress the display time, so as to obtain the adjusted display time; and when the refresh rate is less than or equal to the refresh rate threshold, using a second processing mode to compress the display time, so as to obtain the adjusted display time.

As at least one example embodiment, the first processing mode includes: reducing a time interval between display columns on the predetermined time axis or decreasing the refresh rate.

As at least one example embodiment, the second processing mode includes: reducing a time interval between display columns on the predetermined time axis or decreasing the refresh rate, and redisplaying the same content on the predetermined time axis twice by means of frequency doubling.

As at least one example embodiment, the operation of according to the adjusted display time, controlling the display screen to display the target image includes: setting an operating state of the display screen to a dynamic compensation mode according to the adjusted display time; and displaying the target image on the display screen according to the dynamic compensation mode.

Another aspect of an embodiment of the present disclosure further provides an image display control apparatus. The apparatus includes: an acquisition module, configured to acquire a refresh rate of a display screen; an adjustment module, configured to adjust display time of a target image on a predetermined time axis according to the refresh rate, so as to obtain adjusted display time, wherein the predetermined time axis is a refresh cycle of each frame of the target image when the display screen is at a target refresh rate; and a control module, configured to, according to the adjusted display time, control the display screen to display the target image.

Another aspect of an embodiment of the present disclosure further provides an image display device. The image display device includes: a processor, and a memory and a display which are respectively connected to the processor. The memory stores a program; and when the program is operated, the processor controls the display and executes the image display control method described in any one of the above.

Another aspect of an embodiment of the present disclosure further provides a computer-readable storage medium. The computer-readable storage medium includes a stored program. When the program is operated, a device where the computer-readable storage medium is located is controlled to execute the image display control method described in any one of the above.

Another aspect of an embodiment of the present disclosure further provides a processor. The processor is configured to operate a program. When the image display control method described in any one of the above is executed.

In the embodiments of the present disclosure, by means of acquiring the refresh rate of the display screen, adjusting display time of the target image on the predetermined time axis according to the refresh rate, so as to obtain the adjusted display time, the predetermined time axis being the refresh cycle of each frame of the target image when the display screen is at the target refresh rate, and according to the adjusted display time, controlling the display screen to display the target image, the display time of the target image on the predetermined time axis is correspondingly adjusted by means of different refresh rates, such that the purpose of processing and arranging the display time of the target image on the predetermined time axis is achieved. Therefore, the visual crosstalk of a dynamic image is effectively achieved, and the technical effect of an image display effect is greatly improved, thereby solving the technical problem of visual crosstalk when an LED display screen displays the dynamic image.

### BRIEF DESCRIPTION OF THE DRAWINGS

The accompanying drawings described herein are used to provide a further understanding of the present disclosure, and constitute a part of this invention. The exemplary embodiments of the present disclosure and the description thereof are used to explain the present disclosure, but do not constitute improper limitations to the present disclosure. In the drawings:

FIG. 1 is a schematic diagram of an image uniformly displayed on a time axis according to the prior art.

FIG. 2 is a flowchart of an image display control method according to an embodiment of the present disclosure.

FIG. 3 is a schematic diagram of an image displayed on a time axis according to an embodiment of the present disclosure.

FIG. 4 is a schematic diagram of another image displayed on a time axis according to an embodiment of the present disclosure.

FIG. 5 is a schematic diagram showing that an LED displays a driving module according to an embodiment of the present disclosure.

FIG. 6 is a schematic diagram of an image display control apparatus according to an embodiment of the present disclosure.

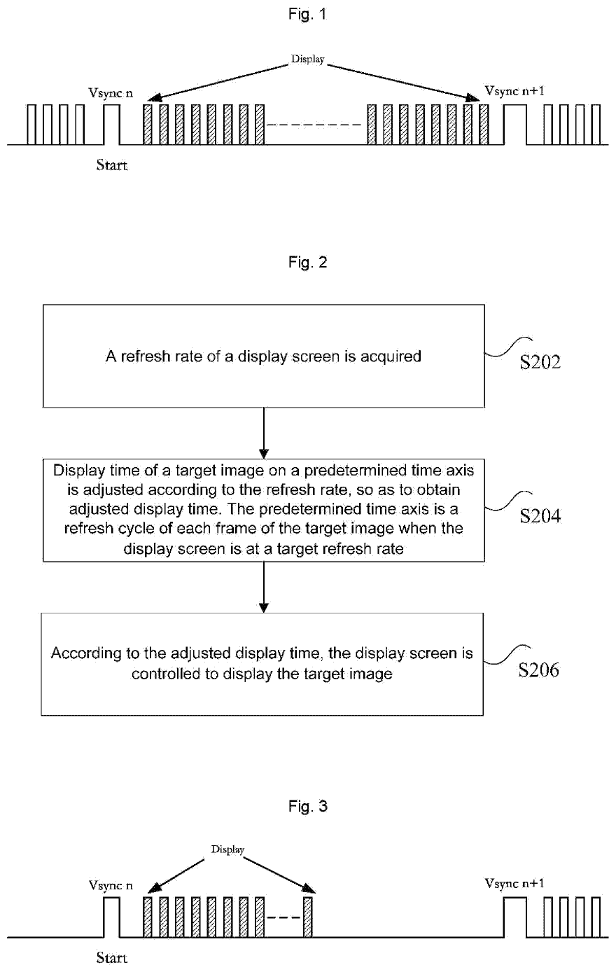

### DETAILED DESCRIPTION OF THE EMBODIMENTS

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those of ordinary skilled in the art without creative work shall fall within the protection scope of the present disclosure.

It is to be noted that terms “first”, “second” and the like in the description, claims and the above drawings of the present disclosure are used for distinguishing similar objects rather than describing a specific sequence or a precedence order. It should be understood that the data used in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

### Embodiment 1

This embodiment of the present disclosure provides an embodiment of an image display control method. It is to be noted that the steps shown in the flowchart of the accompanying drawings may be executed in a computer system, such as a set of computer-executable instructions, and although a logical sequence is shown in the flowchart, in some cases, the steps shown or described may be executed in a different order than here.

FIG. 2 is a flowchart of an image display control method according to an embodiment of the present disclosure. As shown in FIG. 2, the method includes the following steps.

At S202, a refresh rate of a display screen is acquired.

The display screen includes, but is not limited to, display members such as LED, Liquid Crystal Display (LCD), Plasma Display Panel (PDP) and Organic Light-Emitting Diode (OLED). The refresh rate is the number of times that an electron beam repeatedly scans an image on a screen. For example, the refresh rate includes, but is not limited to, 30 Hz, 60 Hz, 90 Hz, 120 Hz, and the like.

At S204, display time of a target image on a predetermined time axis is adjusted according to the refresh rate, so as to obtain adjusted display time. The predetermined time axis is a refresh cycle of each frame of the target image when the display screen is at a target refresh rate.

It is to be noted that, the target refresh rate may be the current refresh rate or a preset refresh rate of the display screen.

At S206, according to the adjusted display time, the display screen is controlled to display the target image.

By means of the above steps, the display time of the target image on the predetermined time axis may be correspondingly adjusted by means of different refresh rates, such that the purpose of processing and arranging the display time of the target image on the predetermined time axis is achieved. Therefore, the visual crosstalk of a dynamic image is effectively achieved, and the technical effect of an image display effect is greatly improved, thereby solving the technical problem of visual crosstalk when an LED display screen displays the dynamic image.

It is to be noted that, the embodiments of the present disclosure may be applied to devices having display screens, such as televisions, tablets and smart phones; and the problem of interframe image visual crosstalk of the dynamic image on the display screen can be effectively solved.

In an optional implementation, the step of adjusting display time of the target image on the predetermined time axis according to the refresh rate, so as to obtain the adjusted display time includes: compressing the display time according to the refresh rate, so as to obtain the adjusted display time. The compression processing is used to compress the duration of the display time on the predetermined time axis.

In an example implementation, the duration of the display time on the predetermined time axis may be compressed according to different refresh rates, so as to obtain the adjusted display time. By means of the implementation, the display time on the predetermined time axis may be processed and arranged, so as to compress the duration of the display time on the predetermined time axis, thereby solving the crosstalk problem of previous and next frames.

In an optional implementation, the step of compressing the display time according to the refresh rate, so as to obtain the adjusted display time includes: judging whether the refresh rate is greater than a refresh rate threshold; when the refresh rate is greater than the refresh rate threshold, using a first processing mode to compress the display time, so as to obtain the adjusted display time; and when the refresh rate is less than or equal to the refresh rate threshold, using a second processing mode to compress the display time, so as to obtain the adjusted display time.

The refresh rate threshold may be set according to a specific application scenario. As at least one example embodiment, the refresh rate threshold may be set to 30 Hz.

In an optional implementation, it is required to judge whether the refresh rate is greater than the refresh rate threshold. When the refresh rate is greater than the refresh rate threshold, the display time may be compressed by reducing a time interval between display columns on the predetermined time axis, so as to obtain the adjusted display time. By means of the implementation, the duration of the display time on the predetermined time axis may be compressed without changing the refresh rate. In addition, the display time may also be compressed by means of decreasing the refresh rate, so as to obtain the adjusted display time. By means of the first processing mode, a light-emitting time zone of the previous and next frame images may be expanded, so as to avoid the generation of crosstalk integration of the previous and next frame portions of human eyes.

In an optional implementation, when the refresh rate is less than or equal to the refresh rate threshold, the time interval between the display columns on the predetermined time axis are required to be reduced first or the refresh rate is required to be decreased, and then the same content on the predetermined time axis is redisplayed twice by means of frequency doubling. By means of the implementation, the problem of flickering of the light-emitting time zone of the previous and next frame images due to expansion when the refresh rate is low may be avoided.

In an optional implementation, the step of according to the adjusted display time, controlling the display screen to display the target image includes: setting an operating state of the display screen to a dynamic compensation mode according to the adjusted display time; and displaying the target image on the display screen according to the dynamic compensation mode.

By means of the implementation, the operating state of the display screen may be set to the dynamic compensation mode by means of the adjusted display time, and the target image is displayed on the display screen according to the dynamic compensation mode, thereby achieving dynamic compensation display of the display screen.

The optional implementation of the present disclosure is described in detail below.

In order to solve crosstalk, in the present disclosure, the light-emitting time for image display is processed and arranged, and details include the following.

FIG. 3 is a schematic diagram of an image displayed on a time axis according to an embodiment of the present disclosure. As shown in FIG. 3, the width of the time for display on the time axis is first compressed by shortening the time between light-emitting columns, and the compression may be achieved by reducing the refresh rate. For example, the time for a field is 16.67 ms, then the light-emitting time is concentrated at the front portion 8.33 ms of each frame, an LED is not displayed at the latter half portion 8.33 ms, and there is no light-emitting axis. Therefore, the light-emitting time zone of the previous and next frames is expanded. During integration for the human eyes, crosstalk integration of the previous and next frame portions of the human eyes is not generated, such that the crosstalk problem of the previous and next frames is solved.

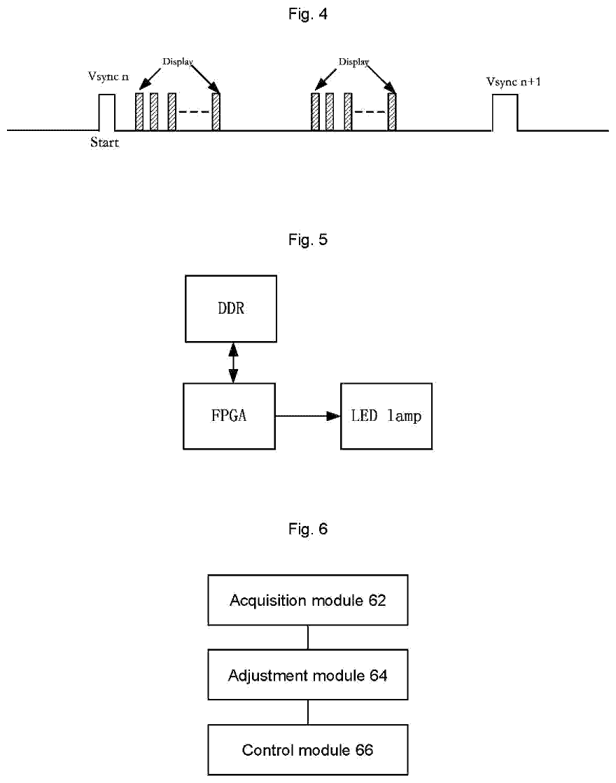

Further, for a video stream with a low frame rate, such as 30 Hz, if no processing is done, the flickering problem occurs according to this display processing method (at a high frame rate such as more than 60 Hz, no flickering occurs). FIG. 4 is a schematic diagram of another image displayed on a time axis according to an embodiment of the present disclosure. As shown in FIG. 4, the same content on the time axis is redisplayed twice by means of frequency doubling, and so on, when the resolution is lower, the number of times of redisplaying is doubled. In principle, a normal video frame rate is at least more than 24 Hz, such that redisplaying is performed twice. Essentially, the time interval between the light-emitting regions should be maintained so as to avoid aliasing in human eye integration.

FIG. 5 is a schematic diagram of an LED display driving module according to an embodiment of the present disclosure. As shown in FIG. 5, when an LED displays a driving module, a Field Programmable Gate Array (FPGA) is required to control the time for taking display pixels from a Double Data Rate (DDR) synchronous dynamic random access memory for the displaying of an LED lamp (which corresponds to the display screen). It is to be noted that, in the LED display screen, the dynamic compensation mode may be set, so as to correspondingly display different video states.

### Embodiment 2

Another aspect of an embodiment of the present disclosure further provides an image display control apparatus. FIG. 6 is a schematic diagram of an image display control apparatus according to an embodiment of the present disclosure. As shown in FIG. 6, the image display control apparatus includes an acquisition module 62, an adjustment module 64 and a control module 66. The image display control apparatus is described in detail below.

The acquisition module 62 is configured to acquire a refresh rate of a display screen. The adjustment module 64 is connected to the acquisition module 62, and is configured to adjust display time of a target image on a predetermined time axis according to the refresh rate, so as to obtain adjusted display time. The predetermined time axis is a refresh cycle of each frame of the target image when the display screen is at a target refresh rate. The control module 66 is connected to the adjustment module 64, and is configured to, according to the adjusted display time, control the display screen to display the target image.

It is to be noted that, each of the above modules may be implemented by software or hardware. For example, for the latter, it may be implemented in the following manners: the above modules are all located in a same processor; and/or the above modules are located in different processors in any combination.

In the embodiments, according to the image display control apparatus, the display time of the target image on the predetermined time axis may be correspondingly adjusted by means of different refresh rates, such that the purpose of processing and arranging the display time of the target image on the predetermined time axis is achieved. Therefore, the visual crosstalk of a dynamic image is effectively achieved, and the technical effect of an image display effect is greatly improved, thereby solving the technical problem of visual crosstalk when an LED display screen displays the dynamic image.

It is to be noted here that, the acquisition module 62, the adjustment module 64 and the control module 66 correspond to S202 to S206 in Embodiment 1, examples and application scenarios implemented by the above modules and the corresponding steps are the same, but are not limited to the contents disclosed in Embodiment 1.

As at least one example embodiment, the adjustment module 64 includes: a processing unit, configured to compress the display time according to the refresh rate, so as to obtain the adjusted display time. The compression processing is used to compress the duration of the display time on the predetermined time axis.

As at least one example embodiment, the processing unit includes: a determination subunit, configured to judge whether the refresh rate is greater than a refresh rate threshold; a first processing unit, configured to, when the refresh rate is greater than the refresh rate threshold, use a first processing mode to compress the display time, so as to obtain the adjusted display time; and a second processing unit, configured to, when the refresh rate is less than or equal to the refresh rate threshold, use a second processing mode to compress the display time, so as to obtain the adjusted display time.

As at least one example embodiment, the first processing mode includes: reducing a time interval between display columns on the predetermined time axis or decreasing the refresh rate.

As at least one example embodiment, the second processing mode includes: reducing a time interval between display columns on the predetermined time axis or decreasing the refresh rate, and redisplaying the same content on the predetermined time axis twice by means of frequency doubling.

As at least one example embodiment, the control module 66 includes: a setting unit, configured to set an operating state of the display screen to a dynamic compensation mode according to the adjusted display time; and a display unit, configured to display the target image on the display screen according to the dynamic compensation mode.

### Embodiment 3

Another aspect of an embodiment of the present disclosure further provides an image display device. The image display device includes: a processor, and a memory and a display which are respectively connected to the processor. The memory stores a program; and when the program is operated, the processor controls the display and executes the image display control method described in any one of the above.

It is to be noted that, the image display device includes, but is not limited to, devices having display screens, such as televisions, tablets and smart phones.

In the embodiments, according to the image display device, the display time of the target image on the predetermined time axis may be correspondingly adjusted by means of different refresh rates, such that the purpose of processing and arranging the display time of the target image on the predetermined time axis is achieved. Therefore, the visual crosstalk of a dynamic image is effectively achieved, and the technical effect of an image display effect is greatly improved, thereby solving the technical problem of visual crosstalk when an LED display screen displays the dynamic image.

### Embodiment 4

Another aspect of an embodiment of the present disclosure further provides a computer-readable storage medium. The computer-readable storage medium includes a stored program. When the program is operated, a device where the computer-readable storage medium is located is controlled to execute the image display control method described in any one of the above.

As at least one example embodiment, in this embodiment, the computer-readable storage medium may be located in any computer terminal in a computer terminal group in a computer network, and/or located in any mobile terminal in a mobile terminal group. The computer-readable storage medium includes the stored program.

As at least one example embodiment, when the program is operated, the device where the computer-readable storage medium is located is controlled to execute the following functions: acquiring a refresh rate of a display screen; adjusting display time of a target image on a predetermined time axis according to the refresh rate, so as to obtain adjusted display time, where the predetermined time axis is a refresh cycle of each frame of the target image when the display screen is at a target refresh rate; and according to the adjusted display time, controlling the display screen to display the target image.

As at least one example embodiment, the function of adjusting display time of the target image on the predetermined time axis according to the refresh rate, so as to obtain the adjusted display time includes: compressing the display time according to the refresh rate, so as to obtain the adjusted display time. The compression processing is used to compress the duration of the display time on the predetermined time axis.

As at least one example embodiment, the function of compressing the display time according to the refresh rate, so as to obtain the adjusted display time includes: judging whether the refresh rate is greater than a refresh rate threshold; when the refresh rate is greater than the refresh rate threshold, using a first processing mode to compress the display time, so as to obtain the adjusted display time; and when the refresh rate is less than or equal to the refresh rate threshold, using a second processing mode to compress the display time, so as to obtain the adjusted display time.

As at least one example embodiment, the first processing mode includes: a reducing time interval between display columns on the predetermined time axis or decreasing the refresh rate.

As at least one example embodiment, the second processing mode includes: reducing a time interval between display columns on the predetermined time axis or decreasing the refresh rate, and redisplaying the same content on the predetermined time axis twice by means of frequency doubling.

As at least one example embodiment, the function of according to the adjusted display time, controlling the display screen to display the target image includes: setting an operating state of the display screen to a dynamic compensation mode according to the adjusted display time; and displaying the target image on the display screen according to the dynamic compensation mode.

### Embodiment 5

Another aspect of an embodiment of the present disclosure further provides a processor. The processor is configured to operate a program. When the image display control method described in any one of the above is executed.

An embodiment of the present disclosure provides a device. The device includes a processor, a memory and a program which is stored on the memory and executable on the processor. When executing the program, the processor implements the following steps: acquiring a refresh rate of a display screen; adjusting display time of a target image on a predetermined time axis according to the refresh rate, so as to obtain adjusted display time, where the predetermined time axis is a refresh cycle of each frame of the target image when the display screen is at a target refresh rate; and according to the adjusted display time, controlling the display screen to display the target image.

As at least one example embodiment, the function of adjusting display time of the target image on the predetermined time axis according to the refresh rate, so as to obtain the adjusted display time includes: compressing the display time according to the refresh rate, so as to obtain the adjusted display time. The compression processing is used to compress the duration of the display time on the predetermined time axis.

As at least one example embodiment, the function of compressing the display time according to the refresh rate, so as to obtain the adjusted display time includes: judging whether the refresh rate is greater than a refresh rate threshold; when the refresh rate is greater than the refresh rate threshold, using a first processing mode to compress the display time, so as to obtain the adjusted display time; and when the refresh rate is less than or equal to the refresh rate threshold, using a second processing mode to compress the display time, so as to obtain the adjusted display time.

As at least one example embodiment, the first processing mode includes: reducing a time interval between display columns on the predetermined time axis or decreasing the refresh rate.

As at least one example embodiment, the second processing mode includes: reducing a time interval between display columns on the predetermined time axis or decreasing the refresh rate, and redisplaying the same content on the predetermined time axis twice by means of frequency doubling.

As at least one example embodiment, the function of according to the adjusted display time, controlling the display screen to display the target image includes: setting an operating state of the display screen to a dynamic compensation mode according to the adjusted display time; and displaying the target image on the display screen according to the dynamic compensation mode.

The present disclosure further provides a computer program product. When being executed on a data processing device, the computer program product is suitable for executing a program initialized with the following method steps: acquiring a refresh rate of a display screen; adjusting display time of a target image on a predetermined time axis according to the refresh rate, so as to obtain adjusted display time, where the predetermined time axis is a refresh cycle of each frame of the target image when the display screen is at a target refresh rate; and according to the adjusted display time, controlling the display screen to display the target image.

As at least one example embodiment, the function of adjusting display time of the target image on the predetermined time axis according to the refresh rate, so as to obtain the adjusted display time includes: compressing the display time according to the refresh rate, so as to obtain the adjusted display time. The compression processing is used to compress the duration of the display time on the predetermined time axis.

As at least one example embodiment, the function of compressing the display time according to the refresh rate, so as to obtain the adjusted display time includes: judging whether the refresh rate is greater than a refresh rate threshold; when the refresh rate is greater than the refresh rate threshold, using a first processing mode to compress the display time, so as to obtain the adjusted display time; and when the refresh rate is less than or equal to the refresh rate threshold, using a second processing mode to compress the display time, so as to obtain the adjusted display time.

As at least one example embodiment, the first processing mode includes: reducing a time interval between display columns on the predetermined time axis or decreasing the refresh rate.

As at least one example embodiment, the second processing mode includes: reducing a time interval between display columns on the predetermined time axis or decreasing the refresh rate, and redisplaying the same content on the predetermined time axis twice by means of frequency doubling.

As at least one example embodiment, the function of according to the adjusted display time, controlling the display screen to display the target image includes: setting an operating state of the display screen to a dynamic compensation mode according to the adjusted display time; and displaying the target image on the display screen according to the dynamic compensation mode.

The serial numbers of the foregoing embodiments of the present disclosure are merely for description, and do not represent the superiority or inferiority of the embodiments.

In the above embodiments of the present disclosure, the description of the embodiments has its own focus. For parts that are not described in detail in a certain embodiment, reference may be made to related descriptions of other embodiments.

In the several embodiments provided in this invention, it should be understood that, the disclosed technical content can be implemented in other ways. The apparatus embodiments described above are merely illustrative. For example, the division of the units may be a logical function division, and there may be other divisions in actual implementation. For example, a plurality of units or components may be combined or integrated into another system, or some features can be ignored, or not implemented. In addition, the displayed or discussed mutual coupling or direct coupling or communication connection may be indirect coupling or communication connection through some interfaces, units or modules, and may be in electrical or other forms.

The units described as separate components may or may not be physically separated. The components displayed as units may or may not be physical units, that is, the components may be located in one place, or may be distributed on the plurality of units. Part or all of the units may be selected according to actual requirements to achieve the purposes of the solutions of this embodiment.

In addition, the functional units in the various embodiments of the present disclosure may be integrated into one processing unit, or each unit may exist alone physically, or two or more than two units may be integrated into one unit. The above integrated unit can be implemented in the form of hardware, or can be implemented in the form of a software functional unit.

If the integrated unit is implemented in the form of the software functional unit and sold or used as an independent product, it can be stored in the computer readable storage medium. Based on this understanding, the technical solutions of the present disclosure essentially or the parts that contribute to the prior art, or all or part of the technical solutions can be embodied in the form of a software product. The computer software product is stored in a storage medium, including a plurality of instructions for causing a computer device (which may be a personal computer, a server, or a network device, and the like) to execute all or part of the steps of the method described in the various embodiments of the present disclosure. The foregoing storage medium includes a USB flash disk, a Read-Only Memory (ROM), a Random Access Memory (RAM), and various media that can store program codes, such as a mobile hard disk, a magnetic disk, or an optical disk.

The above description is merely preferred implementations of the present disclosure, and it should be noted that persons of ordinary skill in the art may also make several improvements and refinements without departing from the principle of the present disclosure, and it should be considered that these improvements and refinements shall all fall within the protection scope of the present disclosure.

What is claimed is:

1. An image display control method, comprising:
acquiring a refresh rate of a display screen;
adjusting display time of a target image on a predetermined time axis according to the refresh rate, so as to obtain adjusted display time, wherein the predetermined time axis is a refresh cycle of each frame of the target image when the display screen is at a target refresh rate; and
according to the adjusted display time, controlling the display screen to display the target image.

2. The method according to claim 1, wherein the adjusting display time of a target image on a predetermined time axis according to the refresh rate, so as to obtain adjusted display time comprises:
compressing the display time according to the refresh rate, so as to obtain the adjusted display time, wherein the compression processing is configured to compress a duration of the display time on the predetermined time axis.

3. The method according to claim 2, wherein the compressing the display time according to the refresh rate, so as to obtain the adjusted display time comprises:
judging whether the refresh rate is greater than a refresh rate threshold;
when the refresh rate is greater than the refresh rate threshold, using a first processing mode to compress the display time, so as to obtain the adjusted display time; and
when the refresh rate is less than or equal to the refresh rate threshold, using a second processing mode to compress the display time, so as to obtain the adjusted display time.

4. The method according to claim 3, wherein the first processing mode comprises:
reducing a time interval between display columns on the predetermined time axis or decreasing the refresh rate.

5. The method according to claim 3, wherein the second processing mode comprises:
reducing a time interval between display columns on the predetermined time axis or decreasing the refresh rate, and redisplaying the same content on the predetermined time axis twice by means of frequency doubling.

6. The method according to claim 1, wherein the according to the adjusted display time, controlling the display screen to display the target image comprises:
setting an operating state of the display screen to a dynamic compensation mode according to the adjusted display time; and
displaying the target image on the display screen according to the dynamic compensation mode.

7. The method according to claim 2, wherein the according to the adjusted display time, controlling the display screen to display the target image comprises:
setting an operating state of the display screen to a dynamic compensation mode according to the adjusted display time; and
displaying the target image on the display screen according to the dynamic compensation mode.

8. The method according to claim 3, wherein the according to the adjusted display time, controlling the display screen to display the target image comprises:
setting an operating state of the display screen to a dynamic compensation mode according to the adjusted display time; and
displaying the target image on the display screen according to the dynamic compensation mode.

9. The method according to claim 4, wherein the according to the adjusted display time, controlling the display screen to display the target image comprises:
setting an operating state of the display screen to a dynamic compensation mode according to the adjusted display time; and
displaying the target image on the display screen according to the dynamic compensation mode.

10. The method according to claim 5, wherein the according to the adjusted display time, controlling the display screen to display the target image comprises:
setting an operating state of the display screen to a dynamic compensation mode according to the adjusted display time; and
displaying the target image on the display screen according to the dynamic compensation mode.

11. An image display device, comprising: a processor, and a memory and a display which are respectively connected to the processor, wherein the memory stores a program; and when the program is operated, the processor controls the display and executes following actions:
acquiring a refresh rate of a display screen;
adjusting display time of a target image on a predetermined time axis according to the refresh rate, so as to obtain adjusted display time, wherein the predetermined time axis is a refresh cycle of each frame of the target image when the display screen is at a target refresh rate; and
according to the adjusted display time, controlling the display screen to display the target image.

12. The image display device according to claim 11, wherein the adjusting display time of a target image on a predetermined time axis according to the refresh rate, so as to obtain adjusted display time comprises:
compressing the display time according to the refresh rate, so as to obtain the adjusted display time, wherein the compression processing is configured to compress a duration of the display time on the predetermined time axis.

13. The image display device according to claim 12, wherein the compressing the display time according to the refresh rate, so as to obtain the adjusted display time comprises:
judging whether the refresh rate is greater than a refresh rate threshold;
when the refresh rate is greater than the refresh rate threshold, using a first processing mode to compress the display time, so as to obtain the adjusted display time; and
when the refresh rate is less than or equal to the refresh rate threshold, using a second processing mode to compress the display time, so as to obtain the adjusted display time.

14. The image display device according to claim 13, wherein the first processing mode comprises:
reducing a time interval between display columns on the predetermined time axis or decreasing the refresh rate.

15. The image display device according to claim 13, wherein the second processing mode comprises:
reducing a time interval between display columns on the predetermined time axis or decreasing the refresh rate, and redisplaying the same content on the predetermined time axis twice by means of frequency doubling.

16. The image display device according to claim 11, wherein the according to the adjusted display time, controlling the display screen to display the target image comprises:
setting an operating state of the display screen to a dynamic compensation mode according to the adjusted display time; and
displaying the target image on the display screen according to the dynamic compensation mode.

17. A computer-readable storage medium, comprising a stored program, wherein, when the program is operated, a device where the computer-readable storage medium is located is controlled to execute following actions:
acquiring a refresh rate of a display screen;
adjusting display time of a target image on a predetermined time axis according to the refresh rate, so as to obtain adjusted display time, wherein the predetermined time axis is a refresh cycle of each frame of the target image when the display screen is at a target refresh rate; and
according to the adjusted display time, controlling the display screen to display the target image.

18. The computer-readable storage medium according to claim 17, wherein the adjusting display time of a target image on a predetermined time axis according to the refresh rate, so as to obtain adjusted display time comprises:
compressing the display time according to the refresh rate, so as to obtain the adjusted display time, wherein the compression processing is configured to compress a duration of the display time on the predetermined time axis.

19. The image display device according to claim 18, wherein the compressing the display time according to the refresh rate, so as to obtain the adjusted display time comprises:
judging whether the refresh rate is greater than a refresh rate threshold;
when the refresh rate is greater than the refresh rate threshold, using a first processing mode to compress the display time, so as to obtain the adjusted display time; and
when the refresh rate is less than or equal to the refresh rate threshold, using a second processing mode to compress the display time, so as to obtain the adjusted display time.

20. The image display device according to claim 19, wherein the first processing mode comprises:
reducing a time interval between display columns on the predetermined time axis or decreasing the refresh rate.
